(19) United States
(12) Patent Application Publication
(10) Pub. No.: US 2004/0212548 A1
(43) Pub. Date: Oct. 28, 2004

(54) Method and system for displaying advertising on an electronic display screen

(76) Inventor: Mark Ruttenberg, Bloomington (IL)

Correspondence Address: BLACKWELL SANDERS PEPER MARTIN LLP, 720 OLIVE STREET, SUITE 2400, ST. LOUIS, MO, 63101, US

(21) Appl. No.: 10/477,811

(22) PCT Filed: May 15, 2002
(86) PCT No.: PCT/US02/15377

Related U.S. Application Data
(60) Provisional application No. 60/291,065, filed on May 15, 2001.

(51) Int. Cl. G09G 5/00

(52) U.S. Cl. 345/1.1

(57) ABSTRACT

A method and system (700) for displaying advertisements on an electronic display is disclosed. This includes using an electronic display (706) that is attached to a processor (708) that receives advertising files and information via a data storage or data transfer device such as a global computer network, e.g. Internet. The appropriate advertising is then downloaded by a particular machine and is displayed within a particular panel on an electronic display. These panels shown on the electronic display can be numerous and vary tremendously. Each advertisement will be looped and reshown for predetermined duration for a predetermined time interval that can flexibly altered form a remote location. Each system machine can receive new downloaded information at a predetermined time interval to delete existing advertisements from the system and download new advertisements. Advertisements can be used across the system or can be specific to a particular region or machine.

### CROSS REFERENCE TO RELATED APPLICATION

This application claims priority of U.S. Provisional Patent Application No. 60/291,065 filed May 15, 2001.

### BACKGROUND OF INVENTION

Traditionally, advertising for local area merchants have been found in newspapers, radio, television, billboards and mailings. Consumers are overwhelmed with much of this advertising. With today's TV remote control devices, many consumers will “flip” TV stations rather than watching commercials. The same is true with radio simply change the station. Billboards can be effective but can be very expensive and most local merchants may not have the advertising budget to spend on billboard advertising. In addition, many consumers don't even bother opening “junk” mail and simply toss it in the wastebasket.

On the other hand, classified advertisements are found in select portions of newspapers or magazines. In some cases, there are magazines devoted exclusively to classified advertisements. The description of the products or services being sold is typically very terse with only a type or model for the goods, the respective age and selling price. This is usually not enough information to allow a reasonably prudent purchaser to make an informed decision. Usually, a follow-up phone call is required not to mention a personal visit to ascertain the value of the specific property in question This type of advertising only attracts people who are in the market for a particular item and go out of their way to read the classified portion of a newspaper or magazine or are so eager to purchase a desired product that they are willing to invest in a specialized classified advertising magazine. There is typically not enough information present in these classified advertisements to attract anyone other than someone who is completely dedicated to purchasing a particular item and willing to follow-up with personal visits and phone calls. These classified advertisements are completely deficient with regard to generating consumer demand and interest and only appeals to people already committed and dedicated to purchasing a particular product and are willing to invest a considerable amount of time and effort in the process.

Another problem plaguing society is that there are numerous places where people are forced to stand in line. This is a tedious and boring process since there is very little, if any visual stimulation. These lines or queues can be found at retail establishments including grocery stores, department stores, hardware stores, banks, amusement parks, hair salons, restaurants, and so forth.

The present invention is directed to overcoming one or more of the problems set forth above.

### SUMMARY OF INVENTION

A method and system for displaying advertisements on an electronic display is disclosed This includes using an electronic display that is attached to a processor that receives advertising files and information via a data storage or a data transfer device such as utilizing a global computer network, e.g. Internet. All contact, payment and advertising information can be inputted to the system. The appropriate adverting is then downloaded by a particular machine and is displayed within a particular panel on an electronic display. These panels shown on the electronic display can be numerous and vary tremendously. Each advertisement will be looped and reshown for a predetermined duration for a predetermined time interval that can flexibly altered from a remote location. Each system machine can receive new downloaded information at a predetermined time interval to delete existing advertisements from the system and download new advertisements. A switch or push buttons can allow the person viewing the display to go toggle back and forth between advertisements and replay those advertisements of particular interest. Advertisements can be used across the system or can be specific to a particular region or machine. A global computer system can provide additional information with searching capability for customers desiring more details about a particular product or service.

These are merely some of the innumerable illustrative aspects of this present invention and should not be deemed an all-inclusive listing.

### BRIEF DESCRIPTION OF DRAWINGS

For a better understanding of the present invention, reference may be made to the accompanying drawings in which:

FIG. 1 illustrates an electrical schematic associated with the system of displaying advertisements on an electronic display associated with the present invention;

FIG. 2 illustrates a front view of a display unit cabinet of the present invention;

FIG. 3 illustrates a cut-away side view of a display unit cabinet of the present invention;

FIG. 4 illustrates a top view of a display unit cabinet of the present invention;

FIG. 5 illustrates a flowchart of the basic business functions associated with the system of displaying advertisements on an electronic display associated with the present invention including obtaining contact information, payment information and advertisement information;

FIG. 6 illustrates a flowchart of the basic database functions associated with the software system of displaying advertisements on an electronic display associated with the present invention;

FIG. 7 illustrates a flowchart of the basic user interface functions associated with the software system of displaying advertisements on an electronic display associated with the present invention;

FIG. 8 is a flowchart illustrating the basic software system of displaying advertisements on an electronic display associated with the present invention;

FIG. 9 illustrates a preferred exemplary panel display layout of the present invention;

FIG. 10 illustrates an alternative embodiment of a panel display layout of the present invention;

FIG. 11 illustrates the preferred three (3) push button input associated with the present invention for a person viewing the advertising program to be able to scan back and forth and go to advertisements of interest and obtain additional information regarding a specific advertisement; and

FIG. 12 is a flowchart illustrating the software subroutine or subprogram for displaying additional information regarding a particular advertisement.

### DETAILED DESCRIPTION

In the following detailed description numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

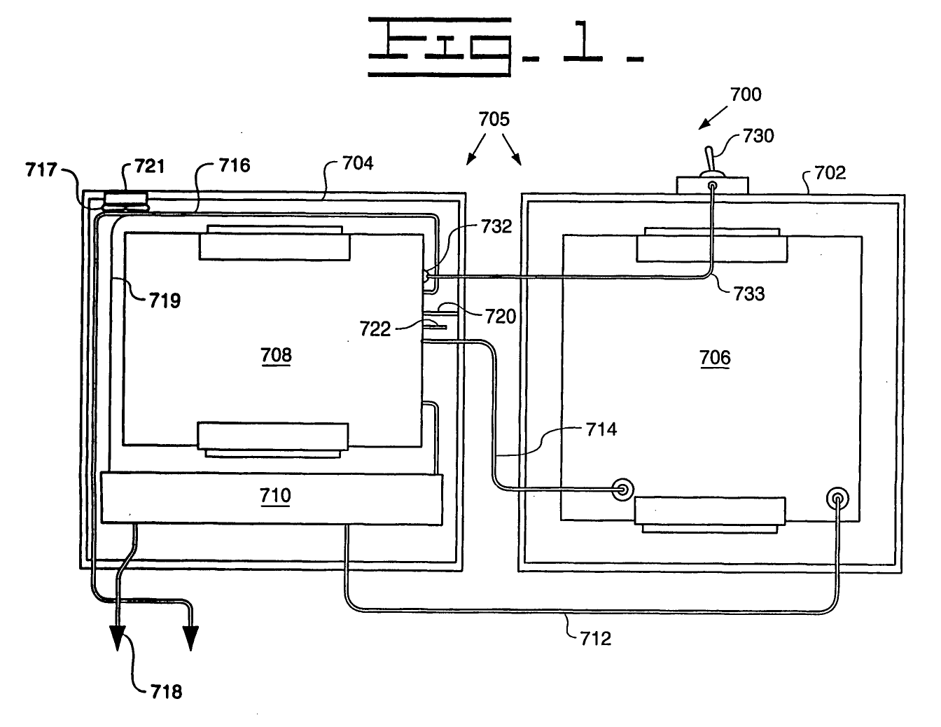

Referring now to FIG. 1, the hardware associated with the electronic display system of the present invention will now be described and is generally indicated by numeral 700. This includes a top panel 702 and a bottom panel 704 for the cabinet generally indicated by numeral 705. Located within the top panel 702 is an electronic display 706, which is a liquid crystal diode display (SGVA) with a display size of 1024×768 pixels that will be described in additional detail below. Although a liquid crystal diode display is preferred, cathode ray tube, plasma screen and other types of electronic displays will suffice. Located within the bottom panel 704 is a processor 708. A processor referred to in this Application can be a single processor or a whole series of processors. Preferably processor 708 is a personal computer, however, a wide variety of electronic computers or electronic controllers will suffice.

There is an electrical surge suppressor outlet strip 710 located in the bottom panel 704 and an electrical connector 712 is located between the electronic display 706 and the electrical surge suppressor outlet strip 710. A VGA connector 714 is located between the electronic display 706 and the processor 708 to provide video information. There is a phone cable 716 connected to an external telephone outlet for connection to a global computer network, e.g., Internet from the processor 708. The preferred method of communication for this invention is through a global computer network, e.g., Internet, however there are numerous mechanisms for electronic communication that might suffice for this present invention and virtually any type of data transfer or data storage device will suffice. Examples of data transfer devices include modems, network cards, such as Ethernet network cards and so forth. Examples of storage devices could include compact disks, computer diskettes, and so forth. In further alternative embodiments, wireless network interfaces are employed using protocols such as Bluetooth, IEEE 802.11b or various conventional wireless telephone standards such as AMPS, NAMPS, TDMA, CDMA, or GSM in connection with a modem.

Also, a particular processor 708 may be networked locally to a high speed internet connection There is an electrical connector 718 connected to an external power source and an electrical ground 720 attached to the bottom panel 704 for the cabinet 705. In the preferred embodiment, there is a fan 717 that runs on twelve volts (d.c.) and provides airflow of at least 30 cubic feet per minute. This fan 717 is powered by a step-down transformer 721 matching the voltage of the fan 717. The fan 717 is connected to the electrical surge suppressor outlet strip 710 via electrical connector 719. Two fans 717 are preferred for optimal cooling of the processor 708.

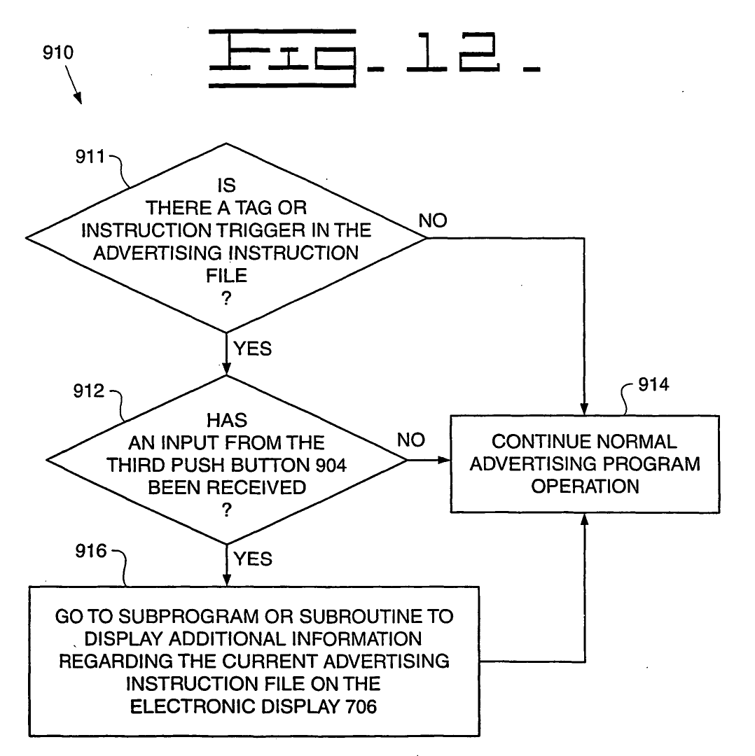

As an additional, optional feature, there is a switch 730, which is preferably but not necessarily a self-centering toggle switch, to allow a person viewing the electronic display 706 to toggle back and forth through advertisements. The flexible and remotely activated advertising program will be resumed in the specific sequence in the previously contracted for advertising program prior to when the self-centering toggle switch 730 was activated. For example, if advertisement number thirty-nine (39) is currently being viewed, the user can go back and view advertisement number fifteen (15). When advertisement number fifteen (15) completes its cycle and the user is no longer using the self-centering toggle switch 730, the program returns to advertisement number thirty-nine (39). This self-centering toggle switch 730 is electrically connected to an input port 732 of the processor 708 by connector 733. However, in the preferred embodiment, as shown in FIG. 11, the person viewing the electronic display 706 is able to move forward through the advertising program with a first push button 902 and backward through the advertising program with a second push button 906. This replicates the same features found when moving the self-centering toggle switch 730 left and right from the center position as described above. For example, the flexible and remotely activated advertising program will be resumed in the specific sequence in the previously contracted for advertising program prior to when either the first push button 902 or the second push button 906 has been pushed. Another feature is a third push button 904, which when activated can provide additional information related to a particular advertisement. Preferably, this third push button 904 will “light-up” when this additional information is available in association with the advertisement that is currently being shown on the electronic display 706. Push buttons 902, 904 and 906 are all connected to an output for the processor 708 such as that provided by connector 733 in FIG. 1.

Advertisement instructions in the corresponding electronic panel instruction files (ACTs) can include a program instruction, e.g., tag, that triggers all output port 722 (See FIG. 1) of the processor 708 that preferably turns on the light in the third push button 904 or merely displays the fact that additional information is available on the electronic display 706. The person viewing the electronic display 706 will preferably notice the light glowing on the third push button 904 or notice the electronic display 706 and activate this third push button 904. This provides an input to the processor 708, which interrupts the advertising program cycle and directs the software program to a subprogram or subroutine that displays pixel information containing additional information about that specific advertisement. This can include, but is not limited to, specific information regarding an advertising sponsor, video advertisements, and so forth. The nature of this additional information is virtually unlimited and would appeal to the person viewing the electronic display 706 that has a strong interest in the products or services shown in that one particular advertisement. When the person viewing the electronic display 706 releases the third push button 904, the flexible and remotely activated advertising program will be resumed in the specific sequence in the previously contracted for advertising program prior to when the third push button 904 was activated.

This function is illustrated on the flowchart that is generally indicated in FIG. 12 by numeral 910. In the description of the flowcharts, the functional explanation marked with numerals in angle brackets, <nnn>, will refer to the flowchart blocks bearing that number.

The first program step <911> is to determine if there is a program instruction, e.g., tag in the electronic panel instruction file (ACT) associated with a particular advertisement. If the answer is negative, the normal advertising program will continue <914>.

The second program step <912> is to determine whether an input has been received from the third push button 904. If no input has been received from the third push button 904, the normal advertising program will again continue <914>. If an input from the third push button 904 has been received, the software program in the processor 708 is directed to a subroutine or subprogram that displays pixel information, which may include videos, on the electronic display 706 <916>. After displaying this additional information or showing the video, the software program then resumes the normal advertising program <914>.

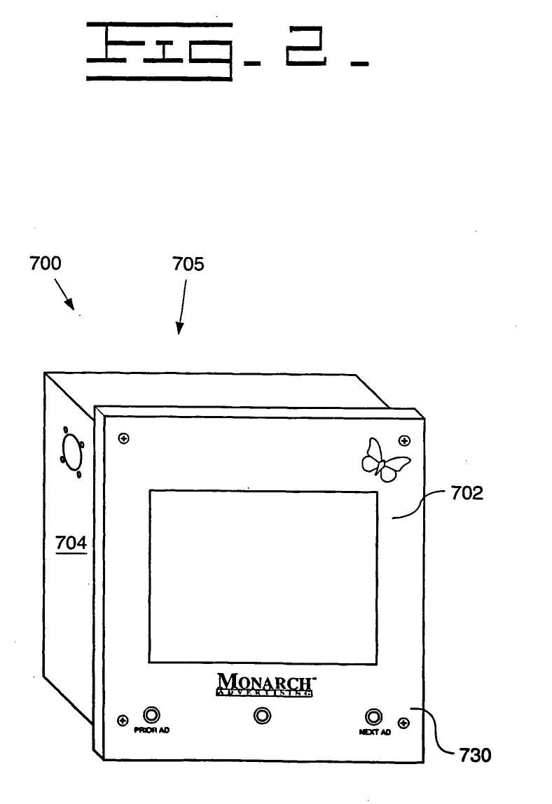

Referring now to FIG. 2, the upper panel 702 of the cabinet 705 for the display system 700 is shown in assembled condition The upper panel 702 includes a frame 730 that can have descriptive material, trademarks and advertising associated with the system of the present invention. Located within the frame 730 is the electronic display 706.

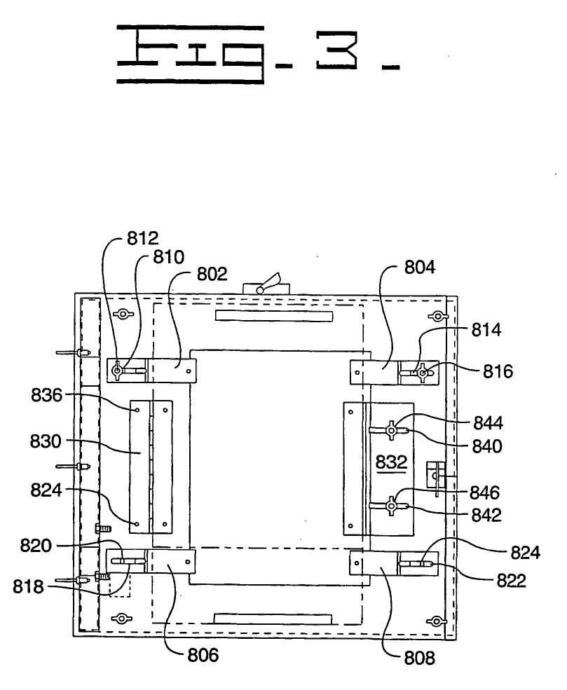

Referring now to FIG. 3, the upper panel 702 of the cabinet 705 includes a 15 first adjustable bracket 802, second adjustable bracket 804, third adjustable bracket 806 and fourth adjustable bracket 808 for securing the electronic display 706 within the upper panel 702. The first adjustable bracket 802 is “L”-shaped and includes an oval groove 810 for adjustment. A wing nut 812 is used to secure this first adjustable bracket 802 to the upper panel 702 of the cabinet 705. The second adjustable bracket 804 is “L”-shaped and includes an oval groove 814 for adjustment. A wing nut 816 is used to secure this second adjustable bracket 804 to the upper panel 702 of the cabinet 705. The third adjustable bracket 806 is “L”shaped” and includes an oval groove 818 for adjustment. A wing nut 820 is used to secure this third adjustable bracket 806 to the upper panel 702 of the cabinet 705. The fourth adjustable bracket 808 is “L”-shaped and includes an oval groove 822 for adjustment. A wing nut 824 is used to secure this fourth adjustable bracket 808 to the upper panel 702 of the cabinet 705.

The bottom panel 704 of the cabinet 705 includes a fifth adjustable bracket 830 and a sixth adjustable bracket 832 for securing the processor 708 within the bottom panel 704. The fifth bracket 830 is “L”-shaped and includes a pair of bolts 834 and 836 to secure the fifth bracket 830 to the bottom panel 704 of the cabinet 705. This fifth bracket 830 does not require adjustment. The sixth adjustable bracket 832 is “L”-shaped and includes a pair of oval grooves 840 and 842 with associated wing nuts 844 and 846 for adjustment to adjustably secure this sixth 5 adjustable bracket 832 to the bottom panel 704 of the cabinet 705. These adjustable brackets 802, 804, 806, 808, 830 and 832 allow the use of components, such as but not limited to processors 708 and electronic displays 706, having varying physical sizes. This will allow easy replacement of components by a field service technician. It also allows use of a wide variety of comparable components from numerous OEM component manufacturers.

There is a hinge 850 for rotatably connecting the upper panel 702 to the lower panel 704 of the cabinet. Both the upper panel 702 has four surrounding sidewalls and the lower panel 704 has four surrounding sidewalls with illustrative examples indicated by numerals 860 and 862, respectively. Venting 864 can also be added to dissipate heat from the processor 708.

Although a single processor 708 associated with a single electronic display 706 is described above, in some applications, multiple electronic displays 706 attached to a single processor 708 may actually be preferred to provide a cost effective mechanism for providing the same desired advertising to intended recipients. In some cases, this occurs within the same physical location.

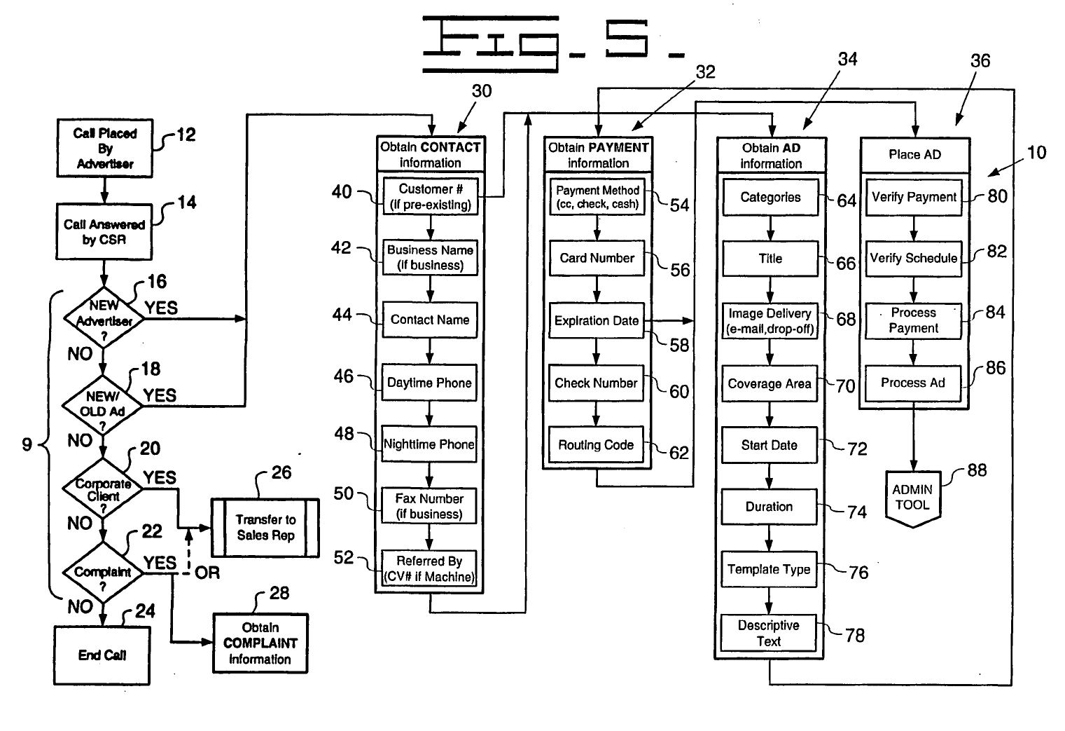

Referring now to the drawings, and initially to FIG. 5, which depicts a flowchart representative of the business system of displaying advertisements on an electronic display associated with the present invention as generally indicated by numeral 10. The invention of the present invention can be utilized for generally advertising as well as classified advertising. For classified advertising, there are additional process steps since, typically, each advertisement has a unique advertiser and requires a separate transaction to place the advertisement on this system.

The following process is preferably for managing a large number of individual advertisers such as that found with classified advertisements, but is not necessary when dealing with a limited number of commercial advertisers. As shown in FIG. 5, the first step in the process is where an advertiser places a telephone call to system personnel associated with the present invention <12>. The telephone is then answered by customer sales representative (system personnel) associated with the present invention <14>. A query is then made as to whether this advertiser on the telephone is a new or current advertiser with the system <16>. If the response to this query is negative and he or she is not a new advertiser, then a query is then made as to whether the advertisement desired for publication by the advertiser is a new or previously displayed advertisement on the system <18>. If the response to this query is negative and the telephone call does not involve a new or previous displayed advertisement, then a query is made as to whether or not it is a corporate client <20>. Process steps <16>, <18> and <20> are preferably performed simultaneously as indicated by numeral 9. If the response to this query in process step <20> is positive and it is a corporate client, then the phone call is transferred to a sales representative associated with the system to address any issues or concerns that corporate representative may have <26>. If the response to this query is negative and it is not a corporate client, then query is made as to whether or not this telephone call is a complaint <22>. If the response to this query is positive and it is a complaint, then the system personnel will obtain the complaint information and take action if appropriate <28>. The phone call can also be transferred to a sales representative associated with the system to address any issues or concerns of that customer <26>. If the response to this query is negative and it is not a complaint, the telephone call will then be ended if there is no further system business to transact <24>.

If the response to the query as to whether this advertiser on the telephone is a new or current advertiser with the system <16> is positive or if the response to the query as to whether the advertisement desired for publication by the advertiser is a new or previously displayed advertisement <18> is positive, then the next step in the process will be to obtain the appropriate contact information from the advertiser, the steps of which are generally indicated by numeral 30.

The first step in obtaining contact information is to determine if there is a 20 pre-existing customer number <40>. If the answer to this query is negative and there is no pre-existing customer number then the business name is requested by the system personnel if it is an entity <42>. The next step is to obtain a contact name <44>, advertiser's daytime phone number <46>, advertiser's nighttime phone number <48>, advertiser's facsimile number (if available) <50> and then the name of the specific display unit machine number that directed the advertiser to this medium <52>.

If the response to the query as to whether there is a pre-existing customer number <40> is positive or after the step of determining the name of the specific display unit machine number that directed the advertiser to this medium <52>, then the next step in the process will be to obtain the appropriate advertising information from the advertiser, the steps of which are generally indicated by numeral 34.

The first step in obtaining advertisement information is to determine the appropriate category or categories for the advertisement <64>. Examples can include, but are not limited to, cars, real estate, rentals, bicycles, sporting goods, events, professional services, retail merchants and so forth. The title of the advertisement is then ascertained <66>. The method of image delivery is determined <68>. Examples can include, but are not limited to, e-mail, drop-off and so forth The coverage area of the advertisement is defined by the advertiser in conjunction with system personnel <70>. The start date for the advertisement is then determined <74> as well as the duration of the advertisement on the system <74>. The type of pictorial template surrounding the advertisement is then selected by the advertiser working with system personnel <76>. Descriptive text is either provided by the advertiser or developed with the assistance of system personnel <78>.

After the step of developing descriptive text for the advertisement <78>, then the next step in the process will be to obtain the appropriate payment information from the advertiser, the steps of which are generally indicated by numeral 32.

The first step in obtaining payment information is to determine the appropriate method of payment <54>. Examples can include, but are not limited to, credit card, check, and cash among other methods. If payment is by means of a credit card then the system personnel inquires as to the credit card number <56> and the expiration date of the credit card <58>. If payment is by means of a check then the system personnel inquires as to the check number <60> and the check routing number <62>.

After the step of determining the check routing code <62> or credit card expiration date <58>, then the next step in the process will be to place the advertisement so that it is displayed by the selected electronic display units during the appropriate time period, the steps of which are generally indicated by numeral 36.

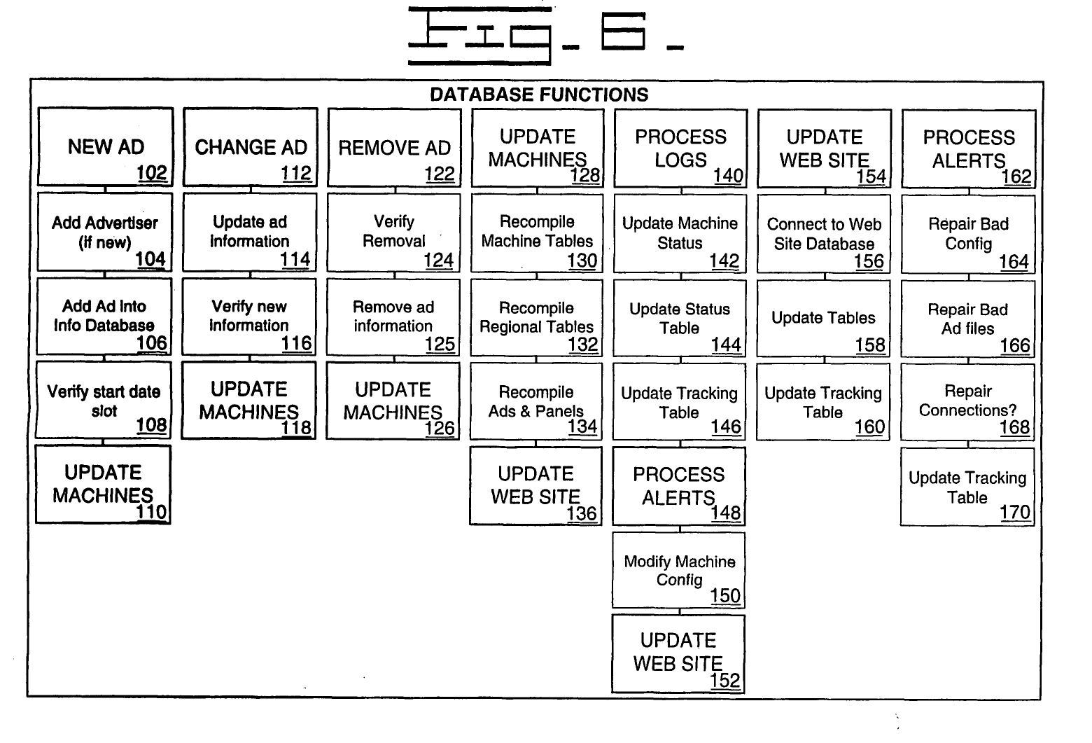

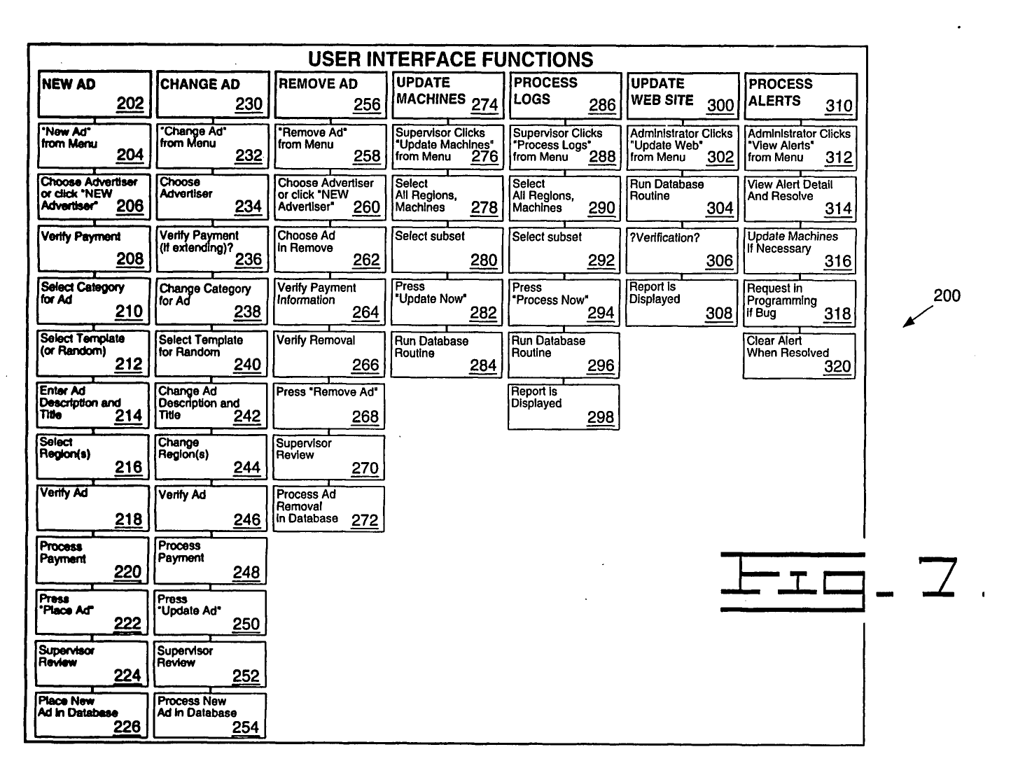

The first step in placing an advertisement is to verify the method of payment <80>. The second step is to verify the specific schedule of the advertisement <82>. The third step will be to process the payment <84> and the fourth step will be to process the advertisement so that it can be electronically displayed on the appropriate electronic display unit(s) <86>. The electronic display system 700 is then controlled by the administrative software program <88>, which includes the database functions generally indicated by numeral 100 in FIG. 6 and the user interface functions generally indicated by numeral 200 in FIG. 7.

Referring now to the database administration functions in FIG. 6, which can be applied when utilizing a few large commercial advertisers or a multitude of classified advertisers, the first function is to place a new advertisement 102. The first step in this first function 102 is to add the advertisement to the database <104>. The next step in this first function 102 is to verify the start date of the advertisement <108>. The final step in this first function 102 is to update the display unit processors with this new information <110>, which will be described later as process 128 under the database functions.

The second function of the database administration functions is to change 20 to an advertisement 112. The first step in this second function 112 is to update the information regarding the advertisement <114>. The next step in this second function 112 is to verify the new information regarding the advertisement <116>. The final step in this second function 112 is to update the display unit processors 708 with this new information <120>, which will be described later as process 128 under the database functions. The first function 102 and second function 112 are functions that are primarily directed to handling larger numbers of advertisers, e.g., classified advertising.

The third function of the database administration functions is to remove an advertisement 122. The first step in this third function 122 is to verify the removal of this advertisement <124>. The next step in this third function 122 is to actually remove the associated advertising information <125>. The final step in this third function 122 is to update the display unit processors 708 with this new information <126>, which will be described later as process 128 under the database functions.

The fourth function of the database administration functions is the previously referenced process of updating the display unit processors 128. The first step in this fourth function 128 is to recompile the data tables having information regarding specific display unit processors <130>. The next step in this fourth function 128 is to recompile the data tables having information regarding regional information <132>. The third step in this fourth function 128 is to reconfigure the size of the modifiable panels that appear on an electronic display 706 and the corresponding electronic panel instruction files (ACTs), which has the digital information that will be displayed within a panel of an electronic display 706 <134>. An example of a portion of an ACT file is shown below in Table 1:

TABLE 1
Sample ACTs File

‘transition type = 1-8 compass direction 45 degree clockwise 9 = zoom 99=random
‘scroll = 1-4 clockwise 90 degrees scroll direction 1-4 < not used −20 to 20 left and
right
‘show = 0 if shown, 1 if not shown
‘tagfile = filename of picture to show when middle button is pressed
‘panel pictures, [seconds to display], [transition type], [order], [file size], [fileID],
[scroll direction 1-4],
‘[speed of scroll],[doNotShow] true< >0 , tag file,[FullScreen] true< >0
‘-------------------------------------------------------------
AC1:A11:StartTime=00:00
AC1:A11:EndTime=23:59
AC1:A11:DefaultAct=1
AC1:PN1:Left=0
AC1:PN1:Top=0
AC1:PN1:Width=100
AC1:PN1:Height=85
AC1:PN1:FILE=trivia_21.swf,25,99,11,250064,,,,0,,0
AC1:PN1:FILE=trivia_22.swf,25,99,21,250278,,,,0,,0
AC1:PN1:FILE=trivia_23.swf,25,99,31,257001,,,,0,,0
AC1:PN1:FILE=trivia_24.swf,25,99,41,250218,,,,0,,0
AC1:PN1:FILE=trivia_25.swf,25,99,51,262359,,,,0,,0
AC1:PN1:FILE=trivia_26.swf,25,99,61,249500,,,,0,,0
AC1:PN1:FILE=trivia_27.swf,25,99,71,273818,,,,0,,0
AC1:PN1:FILE=trivia_28.swf,25,99,81,250019,,,,0,,0
AC1:PN1:FILE=trivia_29.swf,25,99,91,251638,,,,0,,0
AC1:PN1:FILE=trivia_30.swf,25,99,101,265804,,,,0,,0
AC1:PN1:FILE=community_players_singin_1.jpg,15,99,100,62808,,,,0,,0
AC1:PN2:Left=0
AC1:PN2:Top=85
AC1:PN2:Width=100
AC1:PN2:Height=15
AC1:PN2:FILE=monarch_marquee_1.jpg,999,,1,81908,,1,10
‘transition type = 1-8 compass direction 45 degree clockwise 9 = zoom 99=random
‘scroll = 1-4 clockwise 90 degrees scroll direction 1-4 < not used −20 to 20 left and
right
‘show = 0 if shown, 1 if not shown
‘tagfile = filename of picture to show when middle button is pressed
‘panel pictures, [seconds to display], [transition type], [order], [file size], [fileID],
[scroll direction 1-4],
‘[speed of scroll],[doNotShow] true<>0 , tag file,[FullScreen] true<>0

The final step in this fourth function 128 is to update the global computer network, e.g., Internet, website with this newly recompiled data <136> which will be described later as user interface function 300. Communication takes place utilizing file transfer protocols (FTP) or any other type of file transfer protocols. The FTP commands specify the parameters for data connection (data port, transfer mode, representation type and structure) and the nature of the file system operation (store, retrieve, append, delete, etc.). Advertising files only have to be posted once and can be accessed by folders grouped on an international, national, state, district or regional basis. There is flexibility so that files grouped on a regional basis can be modified for a particular machine and that machine determines what advertising files are to be utilized regardless of the folder location on the server. There is not a redundant posting of files with only one uploading per advertisement file to save on global computer network, e.g., Internet, costs and time.

The fifth function of the database administration functions is to process the logs, or in other word, printout predetermined status and operating information 140. These logs can include when the pushbuttons 902, 904 and 906, shown in FIG. 1, are activated by a user of the electronic display system 700. These logs can be for any predetermined time period, e.g., hourly, daily and monthly. There is a log that provides information when the advertisements are shown. An example of a machine log showing the advertisement order and the time of showing in seconds is shown below in Table 2:

TABLE 2
Log of Picture Order and Actual Show Seconds

MACHINE NUMBER 0152 FILE CREATED 3/6/02 8:46:31 AM
INDEX OF FILES
0001 = cookie.jpg
0002 = game.swf
003 = balloon.swf
SHOW TIME IN SECONDS
3/6/02 11:55:01 AM --- 3/6/02 12:25:13 PM
0001 90
0002 90
0003 90
3/6/02 12:56:10 PM --- 3/6/02 1:27:07 PM
0001 90
0002 90
0003 90

Also available is a log for recording when buttons 902, 904, 906 are pressed. An illustrative, but nonlimiting, example of a button log file is shown below in Table 3:

TABLE 3
Button Push Log

MACHINE NUMBER 0120 FILE CREATED 3/29/02 2:45:49 PM
:3/6/02 3:54:28 PM to 02:45 PM >0
:3/29/02 2:45:49 PM to 02:55 PM >0
:3/29/02 2:55:42 PM to 04:15 PM >0
:3/29/02 4:15:15 PM to 09:57 PM >0
:3/29/02 9:57:39 PM to 12:32 AM >0
:3/30/02 12:32:10 AM to 06:00 AM >0
:3/30/02 6:00:48 AM to 01:57 PM >0
:3/30/02 1:57:38 PM to 09:57 PM >0
:3/30/02 9:57:38 PM to 12:32 AM >0
:3/31/02 12:32:11 AM to 06:00 AM >0
:3/31/02 6:00:48 AM to 01:57 PM >0
:3/31/02 1:57:33 PM to 09:57 PM >0
:3/31/02 9:57:33 PM to 12:32 AM >0
:4/1/02 12:32:08 AM to 06:00 AM >0
:4/1/02 6:00:45 AM to 01:57 PM >0
:4/1/02 1:57:35 PM to 09:57 PM >0
:4/1/02 9:57:32 PM to 12:32 AM >0
:4/2/02 12:32:08 AM to 06:00 AM >0
:4/2/02 6:00:46 AM to 01:57 PM >0
:4/2/02 1:57:30 PM to 09:57 PM >0
:4/2/02 9:57:29 PM to 12:32 AM >0
:4/3/02 12:32:12 AM to 06:00 AM >0
:4/3/02 6:00:39 AM to 01:57 PM >0
:4/3/02 1:57:28 PM to 09:57 PM >0
:4/3/02 9:57:28 PM to 12:32 AM >0
:4/4/02 12:32:08 AM to 06:08 AM >0
:4/4/02 6:08:43 AM to 12:50 PM >0
:4/4/02 12:50:08 PM to 12:59 PM >0
:4/4/02 12:59:34 PM to 01:57 PM >0
:4/4/02 1:57:28 PM to 09:57 PM >0
:4/4/02 9:57:24 PM to 12:32 AM >0
:4/5/02 12:32:14 AM to 06:00 AM >0
:4/5/02 6:00:32 AM to 01:57 PM >0
:4/5/02 1:57:26 PM to 04:25 PM >1
:4/5/02 4:25:43 PM to 05:24 PM >16
:4/5/02 5:24:36 PM to 05:35 PM >3
:4/5/02 5:35:25 PM to 05:52 PM >22
:4/5/02 5:52:42 PM to 06:04 PM >1
:4/5/02 6:04:31 PM to 06:25 PM >56
:4/5/02 6:25:20 PM to 06:55 PM >9
:4/5/02 6:55:41 PM to 08:27 PM >6
:4/5/02 8:27:27 PM to 09:57 PM >0
:********DAY*Friday TOTAL Pressed >113

The first step in this fifth function 140 is to update the status of the specific display unit processors 708 <142>. The next step in this fifth function 140 is to update the table that has all of the data relating to the status of the specific display unit processors 708 <144>. The third step in this fifth function 140 is to update a table with system tracking information <146>. As described, the system tracks and documents any and all information about any particular advertisement. The next step in this fifth function 140 is to process this system alert information <148>, which is a separate database function described herein below as step <162>. The fifth step in this fifth function 140 is to modify the configurations of the display unit processors 708 <150>. The final step in this fifth function is to update the system website with this new information <152>, which is a user interface function, described herein below as process step 300.

The sixth function of the database administration functions is to update the system website with new data 154. The first step in this sixth function 154 is to connect to the system database on the system website <156>. The next step in this sixth function 154 is to update the data tables associated with the system <158>. The last step in this sixth function 154 is to update the data tables of tracking information <160>. This sixth function 154 is primarily directed to handling larger numbers of advertisers, e.g., classified advertising.

The seventh and final function of the database administration functions is 20 to provide process alert function to rectify problems with the system 162. The first step in this seventh function 162 is to repair bad configuration files <164>. The next step in this seventh function 162 is to repair bad files containing advertising information/data <166>. The next step in this seventh function 162 is to report all of the corrections of errors that have been made to either advertising or configuration files <168> and the last step in this seventh function 162 is to update the table of tracking information <170>.

Referring now to the user interface functions shown on FIG. 7 and generally indicated by numeral 200, the first function is to place a new advertisement 202. The first step in this first user interface function 202 is to select the “new advertisement” function from a graphical interface menu <204>. The second step 202 in this first user interface function is for the user to select their advertising entity's name or select the “new advertiser” function from a graphical interface menu <206>. The third step in this first user interface function 202 is for the user to verify the type of payment for the advertisement <208>. The fourth step in this first user interface function 202 is to select the category associated with the advertisement <210>. The fifth step in this first user interface function 202 is to select a template for the type of advertisement that will be utilized or to have a random template to frame the advertisement on the display monitor 706 to be selected <212>. The sixth step in this first user interface function 202 is for the user to input the description and tide associated with the advertisement <214>. The seventh step in this first user interface function 202 is for the user to select the geographical regions where he or she desires the advertising to appear <216>. The eighth step in this first user interface function 202 is for the user to verify the advertisement that he or she would like to display <218>. The ninth step in this first user interface function 202 is to process payment based on the designated payment method <220>. The tenth step in this first user interface function 202 is place the advertisement on the system <222> by entering the “place advertisement” on the graphical user interface screen. A supervisor associated with the software system will then review the proposed advertisement <224> and the advertisement will then be placed in the system database <226> as the final step in this first user interface function 202. The third step <208>, the fifth step <212>, and the sixth step <214> of this first user interface function 202 are primarily directed to handling larger numbers of advertisers, e.g., classified advertising, and not necessary when dealing with fewer numbers of commercial advertisers.

The second function of the user interface functions is to change an advertisement 230. The first step in this second user interface function 230 is to select the “change advertisement” function from a graphical interface menu <232>. The second step in this second user interface function 230 is for the user to select their advertising entity's name from a graphical interface menu <234>. The third step in this second user interface function 230 is for the user to verify the type of payment for the advertisement if extending the duration of the advertisement <736>. The fourth step in this second user interface function 230 is to change the category associated with the advertisement <238>. The fifth step in this second user interface function 230 is to select a template for the type of advertisement that will be utilized or to have a random template to frame the advertisement on the display monitor to be selected <240>. The sixth step in this second user interface function 230 is for the user to change the description and/or title associated with the advertisement <242>. The seventh step in this second user interface function 230 is for the user to change the geographical regions where he or she desires the advertising to appear <244>. The eighth step in this second user interface function 230 is for the user to verify the specific advertisement that he or she would like to display <246>. The ninth step in this second user interface function 230 is to process payments based on the designated payment method <248>. The tenth step in this second user interface function 230 is to update the advertisement on the system <250> by entering the “update advertisement” on the graphical user interface screen. A supervisor associated with the software system will then review the proposed advertisement <252> and the advertisement will then be placed in the system database <254> as the final step in this second user interface function 230.

The third step <236>, the fourth step <238>, the fifth step <240>, the sixth step <242> and the ninth step <248> of this second user interface function 230 are primarily directed to handling larger numbers of advertisers, e.g., classified advertising, and not necessary when dealing with fewer numbers of commercial advertisers.

The third function of the user interface functions is to remove an advertisement from the system 256. The first step in this third user interface function 256 is to select the “remove advertisement” function from a graphical interface menu <258>. The second step in this third user interface function 256 is for the user to select their advertising entity's name or select the “new advertiser” function from a graphical interface menu <260>. The third step in this third user interface function 256 is for the user to select the advertisement that he or she desires to remove <262>. The fourth step in this third user interface function 256 is for the user to verify the type of payment mechanism for receiving a credit or make any additional payment <264>. The fifth step in this third user interface function 256 is for the user to verify the advertisement that he or she would like to remove <266>. The sixth step in this third user interface function 256 is to enter the “remove advertisement” input function on the graphical user interface screen. A supervisor associated with the software system will then review the advertisement that will be removed <270> and then the advertisement will then be removed from the database on the system <272> as the final step in this third user interface function 256.

The fourth step <264> of this third user interface function 256 is primarily directed to handling larger numbers of advertisers, e.g., classified advertising, and not necessary when dealing with fewer numbers of commercial advertisers.

The fourth function of the user interface functions is to update the electronic displays 274. The first step in this fourth user interface function 274 is for a supervisor associated with the software system to select the “update machines” function from a graphical interface menu <276>. The second step in this fourth user interface function 274 is for the supervisor to select either “all”, “regions” or specific “machines” from a graphical interface menu to isolate what machines will be updated <278>. The third step in this fourth user interface function 274 is for the supervisor to select the specific subset of displays to update <280>. The fourth step in this fourth user interface function 274 is for the supervisor to click-on the “update now” input to update the selected electronic displays <282>. The fifth step and final step in this fourth user interface function 274 is the actual running of the update software database routine <284>. The fifth function of the user interface functions is to process output logs 286. The first step in this fifth user interface function 284 is for a supervisor associated with the software system to select the “process logs” function from a graphical interface menu <288>. The second step in this fifth user interface function 284 is for the supervisor to select either “all”, “regions” or specific “machines” from a graphical interface menu to isolate what machines will be updated <290>. The third step in this fifth user interface function 284 is for the supervisor to select the specific subset of displays to update <292>. The fourth step in this fifth user interface function 284 is for the supervisor to click-on the “process now” input to generate the output logs <294>. The fifth step in this fifth user interface function 284 is the actual running of the database software routine for outputting logs <296> and the sixth step and final step in this fifth user interface function 284 is the actual outputting of the report logs <398>.

The sixth function of the user interface functions is to update the system 30 global computer network, e.g., Internet website 300. The first step in this sixth user interface function 300 is for a supervisor associated with the software system to select the “update web” input function from a graphical interface menu <302>. The second step in this sixth user interface function 300 is for the supervisor to run the database software routine <304>. The third step in this sixth user interface function 300 is verification that the database software routine has been run <306>. The fourth step and final step in this sixth user interface function 300 is for the system to display a report regarding this website update for optional printout <308>.

The seventh and final function of the user interface functions is a process alerts function 310. The first step in this seventh user interface function 310 is for a supervisor associated with the software system to select the “view alerts” input function from a graphical interface menu <312>. The second step in this seventh user interface function 310 is for the supervisor view the system notifications and the potential resolutions associated therewith <316>. The third step in this seventh user interface function 310 is to update the machines if that is necessary <316>. The fourth step in this seventh user interface function 310 is to request that programming fix a problem in the system <318>. The fifth and final step in this seventh user interface function 310 is to clear the alert status when the problem is resolved. This system is able to resolve scheduling conflicts and facilitate scheduling functions.

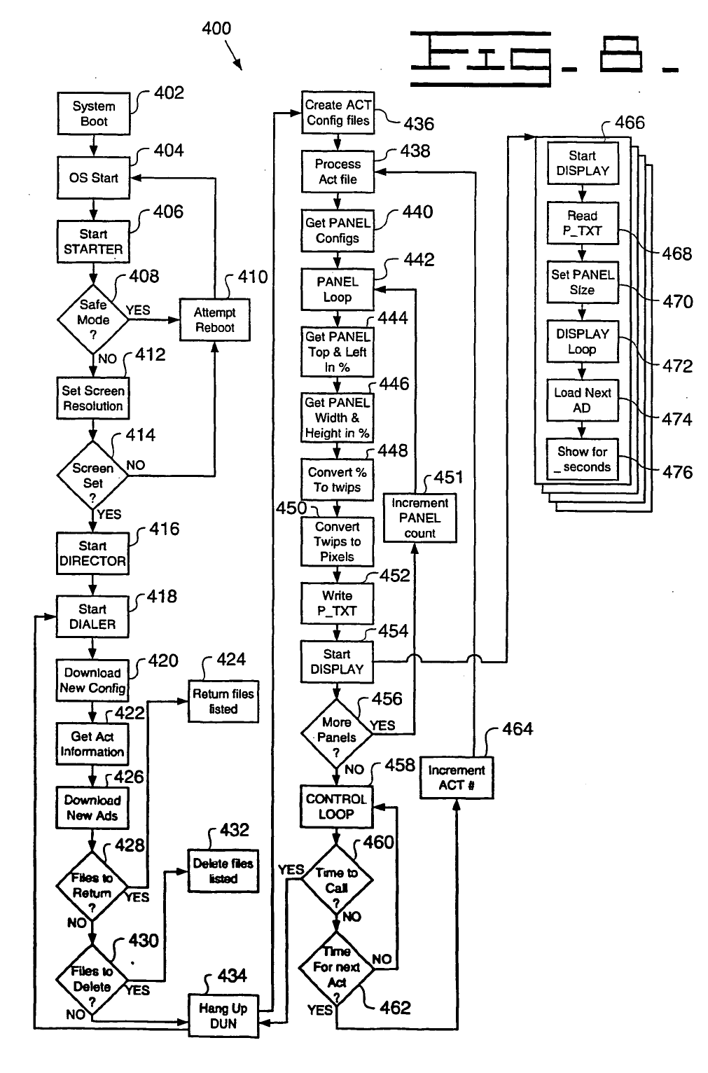

Referring now to FIG. 8, which depicts a flowchart representative of the software system of displaying advertisements on an electronic display associated with the present invention as generally indicated by numeral 400.

The first step in the process is to boot-up the software system of the present invention <402>. The second step is to start the operating system <404> and initiate a starter program <406>. A determination is made if the operating system is in a safe mode <408>. If the response to this query is positive, there is an attempted reboot of the system <408> and the program returns to program step <404> to restart the operating system If the response to this query is negative and the operating system is not in a safe mode, then the software sets the resolution of the display screen <412>. The preferred resolution is a pixel display of 1024×768 pixels. The preferred electronic display is a liquid crystal display, however, any electronic display will suffice such as a plasma screen, a cathode ray tube and so forth.

A determination is made as to whether the screen resolution can be set. If the response to this query is negative, there is an attempted reboot of the system <410> and the program returns to program step <404> to restart the operating system. If the response to this query is positive, then the “Director” program is initiated, which is a dial-up program to connect to an global computer network, e.g., Internet, service provider (ISP) <416>. The first step in this Director program is to start a dial-up function <418>. The system FTP Internet site will allow uploading and downloading of instructions and logged events. An illustrative, but nonlimiting, example of an uploaded machine log file is shown below in Table 4:

TABLE 4
Uploaded Log File

MACHINE NUMBER 0102 FILE CREATED 4/11/02 2:05:53 AM
02 8:09:13 AM > Excluded files = pub.jpg , monarch_marquee_1.jpg ,
:DI:4/9/02 8:09:13 AM > Information gathering completed
:DI:4/9/02 8:09:14 AM > Director OK
:DS:4/9/02 8:09:24 AM > Displayer #1 , Act #1 starting...
:DS:4/9/02 8:09:24 AM > Displayer #2 , Act #1 starting...
:DI:4/9/02 10:00:03 AM > Director OK
:DI:4/9/02 12:00:03 PM > Director OK
:DI:4/9/02 2:00:03 PM > Director OK
:DI:4/9/02 4:00:04 PM > Director OK
:DI:4/9/02 6:00:05 PM > Director OK
:DI:4/9/02 8:00:06 PM > Director OK
:DI:4/9/02 10:00:06 PM > Director OK
:ACT1-DS1:4/10/02 12:29:56 AM > Displayer doesn't see Director running!
:ACT1-DS1:4/10/02 12:29:59 AM > Forcing Reboot !
:ACT1-DS2:4/10/02 12:29:59 AM > Displayer doesn't see Director running!
:ACT1-DS2:4/10/02 12:30:02 AM > Forcing Reboot !
:ST:4/10/02 12:31:24 AM > Version Ver. 4.1bcmb 03/22/02 bc 2002
:ST:4/10/02 12:31:30 AM > MACHINE START ok
:ST:4/10/02 12:31:32 AM > Starting Director
:DI:4/10/02 12:31:32 AM > Director Started...
:DI:4/10/02 12:31:36 AM > NO call Time
:ST:4/10/02 12:31:39 AM > CV_Director.exe Started successfully... logging out
:ST:4/10/02 12:31:40 AM > Starting System Monitor
:ST:4/10/02 12:31:40 AM > Could Not find C:\CORE\CV_Monitor.exe
:DI:4/10/02 12:31:47 AM > >>>> Processing Small ACT File
:DI:4/10/02 12:31:47 AM > Excluded files = pub.jpg ,monarch_marquee_1.jpg ,
:DI:4/10/02 12:31:48 AM > Information gathering completed
:DI:4/10/02 12:31:49 AM > Director OK
:DS:4/10/02 12:31:58 AM > Displayer #1 , Act #1 starting...
:DS:4/10/02 12:31:58 AM > Displayer #2 , Act #1 starting...
:DI:4/10/02 2:00:05 AM > Director OK
:DI:4/10/02 2:02:05 AM > Information gathering started
:DI:4/10/02 2:02:37 AM > Starting Dialer
:DL:4/10/02 2:03:38 AM > Connected Successfully...
:DI:4/10/02 2:03:50 AM > FTP site Connected - Server returns Code 200 28
:DI:4/10/02 2:03:58 AM > This Log Uploaded
:DI:4/10/02 2:04:17 AM > No new Spielberg file found
:DI:4/10/02 2:04:27 AM > Small Spielberg file not found
:DI:4/10/02 2:04:30 AM > Processing Files to be returned
:DI:4/10/02 2:04:35 AM > Processing Files to be deleted
:DI:4/10/02 2:04:46 AM > SUCCESSFULLY DELETED FILES ,
c:\core\pictures\trivia*.*
:DI:4/10/02 2:04:47 AM > Processing Files to be downloaded
:DI:4/10/02 2:04:52 AM > Processing Upgrade Files to be downloaded
:DI:4/10/02 2:04:58 AM > Processing Directory listings to be returned
:DI:4/10/02 2:05:03 AM > Processing Exclude from Act File
:DI:4/10/02 2:05:07 AM > Processing Act File
:DI:4/10/02 2:05:17 AM > Small ACT File downloaded
:DI:4/10/02 2:05:17 AM > ACT File downloaded
:DI:4/10/02 2:05:17 AM > >>>> Processing Small ACT File
:DI:4/10/02 2:05:18 AM > Excluded files = pub.jpg,monarch_marquee_1.jpg ,
:DI:4/10/02 2:05:18 AM > ACTS Parsed successfully
:DI:4/10/02 2:05:19 AM > .......DOWNLOADING ACT DEFINED FILES ..................
:DI:4/10/02 2:05:19 AM > ..................ACT DEFINITION FILE NUMBER 1
:DI:4/10/02 2:06:10 AM > ..................PANEL NUMBER 1
:DI:4/10/02 2:06:10 AM > PIC: Downloaded trivia_21.swf from Server dir
advermain\STA1
:DI:4/10/02 2:07:00 AM > PIC: Downloaded trivia_22.swf from Server dir
advermain\STA1
:DI:4/10/02 2:07:53 AM > PIC: Downloaded trivia_23.swf from Server dir
advermain\STA1
:DI:4/10/02 2:08:45 AM > PIC: Downloaded trivia_24.swf from Server dir
advermain\STA1
:DI:4/10/02 2:09:39 AM > PIC: Downloaded trivia_25.swf from Server dir
advermain\STA1
:DI:4/10/02 2:10:31 AM > PIC: Downloaded trivia_26.swf from Server dir
advermain\STA1
:DI:4/10/02 2:11:29 AM > PIC: Downloaded trivia_27.swf from Server dir
advermain\STA1
:DI:4/10/02 2:12:32 AM > PIC: Downloaded trivia_28.swf from Server dir
advermain\STA1
:DI:4/10/02 2:13:23 AM > PIC: Downloaded trivia_29.swf from Server dir
advermain\STA1
:DI:4/10/02 2:14:17 AM > PIC: Downloaded trivia_30.swf from Server dir
advermain\STA1
:DI:4/10/02 2:14:17 AM > ............Already have > acme.jpg ,:DI:4/10/02 2:14:17
AM > ...DOWNLOAD TIME = 0 hours 9 minutes 58 seconds
:DI:4/10/02 2:14:17 AM > ..................DONE DOWNLOADING PICTURE
FILES..................
:DI:4/10/02 2:14:18 AM > Requested to download 10 picture files
:DI:4/10/02 2:14:18 AM > Successfully downloaded 10 picture files
:DI:4/10/02 2:14:18 AM > 100% OF PICTURES DOWNLOADED OR FOUND
:DI:4/10/02 2:14:18 AM > Done with FTP
:DI:4/10/02 2:14:19 AM > Ad Show Times Log(s) Uploaded
:DI:4/10/02 2:14:26 AM > Uploaded CVShow_020409_0102_.log
:DI:4/10/02 2:14:29 AM > Uploaded CVShow_020410_0102_.log
:DI:4/10/02 2:14:29 AM > This Log Uploaded
:DI:4/10/02 2:14:33 AM > ...ON LINE TIME = −1 hours 11 minutes 48 seconds
:DI:4/10/02 2:14:42 AM > Information gathering completed
:DS:4/10/02 2:14:52 AM > Displayer #1 , Act #1 starting...
:DS:4/10/02 2:14:53 AM > Displayer #2 , Act #1 starting...
:ST:4/10/02 8:08:50 AM > Version Ver. 4.1bcmb 03/22/02 bc 2002
:ST:4/10/02 8:08:56 AM > MACHINE START ok
:ST:4/10/02 8:08:58 AM > Starting Director
:DI:4/10/02 8:08:58 AM > Director Started...
:DI:4/10/02 8:09:02 AM > NO call Time
:ST:4/10/02 8:09:05 AM > CV_Director.exe Started successfully... logging out
:ST:4/10/02 8:09:05 AM > Starting System Monitor
:ST:4/10/02 8:09:06 AM > Could Not find C:\CORE\CV_Monitor.exe
:DI:4/10/02 8:09:13 AM > >>>> Processing Small ACT File
:DI:4/10/02 8:09:13 AM > Excluded files = pub.jpg ,monarchjpg
:DI:4/10/02 8:09:13 AM > Information gathering completed
:DI:4/10/02 8:09:14 AM > Director OK
:DS:4/10/02 8:09:24 AM > Displayer #1 , Act #1 starting...
:DS:4/10/02 8:09:24 AM > Displayer #2 , Act #1 starting...
:DI:4/10/02 10:00:03 AM > Director OK
:DI:4/10/02 12:00:05 PM > Director OK
:DI:4/10/02 2:00:04 PM > Director OK
:DI:4/10/02 4:00:06 PM > Director OK
:DI:4/10/02 6:00:06 PM > Director OK
:DI:4/10/02 8:00:00 PM > Director OK
:DI:4/10/02 10:00:04 PM > Director OK
:ACT1-DS1:4/11/02 12:29:55 AM > Displayer doesn't see Director running!
:ACT1-DS2:4/11/02 12:29:58 AM > Displayer doesn't see Director running!
:ACT1-DS1:4/11/02 12:29:58 AM > Forcing Reboot !
:ACT1-DS2:4/11/02 12:30:01 AM > Forcing Reboot !
:ST:4/11/02 12:31:23 AM > Version Ver. 4.1bcmb 03/22/02 bc 2002
:ST:4/11/02 12:31:29 AM > MACHINE START ok
:ST:4/11/02 12:31:31 AM > Starting Director
:DI:4/11/02 12:31:31 AM > Director Started...
:DI:4/11/02 12:31:35 AM > NO call Time
:ST:4/11/02 12:31:38 AM > CV_Director.exe Started successfully... logging out
:ST:4/11/02 12:31:39 AM > Starting System Monitor
:ST:4/11/02 12:31:39 AM > Could Not find C:\CORE\CV_Monitor.exe
:DI:4/11/02 12:31:46 AM > >>>> Processing Small ACT File
:DI:4/11/02 12:31:46 AM > Excluded files = pub.jpg , ,monarch_marquee_1.jpg ,
:DI:4/11/02 12:31:47 AM > Information gathering completed
:DI:4/11/02 12:31:48 AM > Director OK
:DS:4/11/02 12:31:57 AM > Displayer #1 , Act #1 starting...
:DS:4/11/02 12:31:57 AM > Displayer #2 , Act #1 starting...
:DI:4/11/02 2:00:05 AM > Director OK
:DI:4/11/02 2:02:05 AM > Information gathering started
:DI:4/11/02 2:02:37 AM > Starting Dialer
:DL:4/11/02 2:03:38 AM > Connected Successfully...
:DI:4/11/02 2:03:51 AM > FTP site Connected - Server returns Code 200 28
:DI:4/11/02 2:03:57 AM > This Log Uploaded
:DI:4/11/02 2:04:19 AM > No new Spielberg file found
:DI:4/11/02 2:04:29 AM > Small Spielberg file not found
:DI:4/11/02 2:04:32 AM > Processing Files to be returned
:DI:4/11/02 2:04:38 AM > Processing Files to be deleted
:DI:4/11/02 2:04:44 AM > Processing Files to be downloaded
:DI:4/11/02 2:04:50 AM > Processing Upgrade Files to be downloaded
:DI:4/11/02 2:04:55 AM > Processing Directory listings to be returned
:DI:4/11/02 2:05:01 AM > Processing Exclude from Act File
:DI:4/11/02 2:05:05 AM > Processing Act File
:DI:4/11/02 2:05:14 AM > Small ACT File downloaded
:DI:4/11/02 2:05:14 AM > ACT File downloaded
:DI:4/11/02 2:05:15 AM > >>>> Processing Small ACT File
:DI:4/11/02 2:05:15 AM > Excluded files = pub.jpg, monarch_marquee_1.jpg
:DI:4/11/02 2:05:15 AM > ACTS Parsed successfully
:DI:4/11/02 2:05:16 AM > .......DOWNLOADING ACT DEFINED FILES ..................
:DI:4/11/02 2:05:16 AM > ..................ACT DEFINITION FILE NUMBER 1
:DI:4/11/02 2:05:16 AM > ............Already have acme.jpg
:DI:4/11/02 2:05:16 AM > ...DOWNLOAD TIME = 0 hours 0 minutes 0 seconds
:DI:4/11/02 2:05:17 AM > ..................DONE DOWNLOADING PICTURE
FILES ..................
:DI:4/11/02 2:05:17 AM > Requested to download 1 picture files
:DI:4/11/02 2:05:17 AM > Successfully downloaded 0 picture files
:DI:4/11/02 2:05:17 AM > 100% OF PICTURES DOWNLOADED OR FOUND
:DI:4/11/02 2:05:17 AM > Done with FTP
:DI:4/11/02 2:05:19 AM > Ad Show Times Log(s) Uploaded
:DI:4/11/02 2:05:25 AM > Uploaded CVShow_020410_0102_.log
:DI:4/11/02 2:05:29 AM > Uploaded CVShow_020411_0102_.log
:DI:4/11/02 2:05:29 AM > This Log Uploaded
:DI:4/11/02 2:05:32 AM > ...ON LINE TIME = −1 hours 2 minutes 44 seconds
:DI:4/11/02 2:05:42 AM > Information gathering completed
FILE PARSED 4/11/02 2:05:53 AM
MACHINE NUMBER 0102 VERSION Ver. 4.1bcmb 03/22/02 bc 2002

As reference above, the Spielberg is a specialized hardware/firmware instruction set. An illustrative, but nonlimiting, example of a Spielberg file is shown below in Table 5.

TABLE 5
Spielberg File

| ‘ all ’ are ignored | |
|---|---|
| ‘st:=starter | |
| ‘dl:=dialer | |
| ‘di:=director | |
| ‘ds:=displayer | |
| ‘gn:=general | |
| ‘CHAMPAIGN DIS3 353-7800 | |
| ‘General constants | |
| ‘----------------------------------------- | |
| ‘ | force a reboot right after download of this file with or without doing dialup |
| ‘ | 0 =dont reboot 1= reboot without dial 2=forceshutdown |
| gn:forcereboot=0 | |
| ‘ | how often in minutes picture show time log should write to log |
| gn:writelogpicmins=30 | |
| ‘ | name of log that track total picture show time (prefix to> Show + date |
| gn:logpicfile=CVShow | |
| ‘ | text file list of files to download (somewhat redundant to ACTS) |
| gn:download=download.txt | |
| ‘ | local text file of time and size of last download.txt |
| gn:lastdownload=lastdownload.txt | |
| ‘ | text file list of files to exclude from ACTS |
| gn: exclude=exclude.txt | |
| ‘ | local text file of time and size of last exclude.txt |
| gn:lastexclude=lastexclude.txt | |
| ‘ | number of minutes to count button pushes |
| gn:buttoncountmins=60 | |
| ‘ | text file list of directory listings to return (puts RT_on returned file) |
| gn:returndir=returndir.txt | |
| ‘ | text file directory listing is returned in |
| gn:returndirtext=returndirtext.txt | |
| ‘ | local text file of time and size of last returndir.txt |
| gn:lastreturndir=lastreturndir.txt | |
| ‘ | text file list of files to return |
| gn:returnfile=returnfile.txt | |
| ‘ | local text file of time and size of last returnfile.txt |
| gn:lastreturnfile=lastreturnfile.txt | |
| ‘ | text file list of files to delete (must be full path or begin with / to branch off |
| main app ) | |
| gn:killfile=killfile.txt | |
| ‘ | local text file of time and size of last killfile.txt |
| gn:lastkillfile=lastkillfile.txt | |
| ‘ | local text file of time and size of last spielberg.txt (this file) |
| gn:lastspielbergfile=lastspielbergfile.txt | |
| ‘ | prefix of name of machine FTP directory |
| gn:webdirprefix =advermain\CV | |
| ‘ | name of region FTP directory |
| gn: webdirregion=advermain\REG1 | |
| ‘ | name of group FTP directory |
| gn: webdirgroup=advermain\GROUP1 | |
| ‘ | name of district FTP directory |
| gn:webdirdistrict=advermain\DIS3 | |
| ‘ | name of state FTP directory |
| gn:webdirstate=advermain\STA1 | |
| ‘ | name of trouble notification FTP directory |
| gn:webdirtrouble=advermain\CV_Trouble | |
| ‘ | main Dialer DUN |
| gn:maindialer=MainDialer | |
| ‘ | Name of file with Machine ID |
| gn:meidtxt=MeId.txt | |
| ‘ | seconds to wait for dialer to connect after starting |
| gn:timetowait=50 | |
| ‘ | number of trys dialer will try before giving up (not same as DUN setting) |
| gn:numtrys=3 | |
| ‘ | file that flags when director program starts |
| gn:directorok=DirOK.txt | |
| ‘ | flag file to notify that dialer program started |
| gn: dialerok=DialOK.txt | |
| ‘ | name of upgrade directory |
| gn:upgradefolder=upgrades | |
| ‘ | ok text constant |
| gn:ok=OK | |
| ‘ | Unknown text constant |
| gn:unknown=UNKNOWN | |
| ‘ | Maximum size of log |
| gn:maxlogsize=40000 | |
| ‘ | log file name |
| gn:cvlog=CV | |
| ‘ | Already have pics log file name |
| gn:cvAlreadylog=CVAlready | |
| ‘ | Maximum size of button log |
| gn:maxbuttonlogsize=30000 | |
| ‘ | log button file name |
| gn:cvbuttonlog=CVButton | |
| ‘ | makes the director call instantly upon restart |
| gn:noinstdialfile=noInstDial.txt | |
| ‘ | if there are files that have a jump to or tag file then show the small indicator |
| TRUE OR FALSE | |
| gn:showjumptags= | |
| ‘ | if there are files that have a jump to or tag file then allow middle button to |
| jump to file TRUE OR FALSE | |
| gn:activatejumps= | |
| ‘ | DO not show add number TRUE OR FALSE |
| gn:donotshowadnumbers= | |
| ‘ | How many numbered small act files to look for |
| gn:numberofsmallacts=5 | |
| ‘STARTER constants | |
| ‘----------------------------------------- | |
| ‘ | Vertical resolution of display |
| st:vrez=768 | |
| ‘ | Horizontal resolution of display |
| st:hrez=1024 | |
| ‘ | color bit depth of display |
| st:colors=24 | |
| ‘ | picture when machine starts - expands out |
| st:mainpic=CV_START.jpg | |
| ‘ | picture when a problem with machine occurs |
| st:retrypic=CV_Retry.jpg | |
| ‘ | seconds user intervention (keypress) can stop program |
| st:startinterrupter=5 | |
| ‘ | seconds CV_Starter.exe program waits for CV_Director.exe to start |
| st:directorstart=60 | |
| ‘ | seconds between checks of CV_Starter.exe looking for CV_Director.exe |
| st:dirchecksecs=3 | |
| ‘ | name of Director program |
| st:directorprog=CV_Director.exe | |
| ‘ | name of Monitor program |
| st:monitorprog=CV_Monitor.exe | |
| ‘ | name of file that logs last reboot time |
| st:lastreboottry=lastTry.txt | |
| ‘ | file that keeps track of number of reboots attempted |
| st:numberoftrys=numberTry.txt | |
| ‘ | number of trys to reboot at one time |
| st:trythismanyreboots=3 | |
| ‘ | seconds to wait after number of retrys attempted to try again |
| st:waitforreboot=3600 | |
| ‘ | beginning of every line written to log by starter |
| st:stlinebegin=ST | |
| ‘DIALER constants | |
| ‘----------------------------------------- | |
| ‘ | name of main DUN |
| dl:maindialer=MainDialer | |
| ‘ | user name for ISP |
| dl:dialeruser=********** | |
| ‘ | password for ISP |
| dl:dialerpassword=******** | |
| ‘ | phone number for ISP |
| dl:dialerphone=********* | |
| ‘ | user name for emergency ISP |
| dl:emergdialeruser= | |
| ‘ | password for emergency ISP |
| dl:emergdialerpassword= | |
| ‘ | phone number for emergency ISP |
| dl:emergdialerphone= | |
| ‘ | number of seconds to check that dialer started |
| dl:dialchecks=3 | |
| ‘ | beginning of every line writen to log by dialer |
| dl:dllinebegin=DL | |
| ‘ | |
| ‘The dialer will not call in between these times | |
| ‘they will be stored in register once recieved | |
| ‘ send default date of DEFAULTCALLTIME = 1:11 to clear entrys | |
| ‘ NOTE both start and end times must be sent to make settings | |
| dl:NoCallStartTime1= | |
| ‘ | |
| dl:NoCallStartTime2= | |
| ‘ | |
| dl:NoCallStartTime3= | |
| ‘ | |
| dl:NoCallEndTime1= | |
| ‘ | |
| dl:NoCallEndTime2= | |
| ‘ | |
| dl:NoCallEndTime3= | |
| ‘DIRECTOR constants | |
| ‘----------------------------------------- | |
| ‘ | name of Dialer program |
| di:dialerprog=CV_DIALER.exe | |
| ‘ | how often to check if it is time to call in |
| di:chkcalltimesecs=1800 | |
| ‘ | how often to check if it is time to change acts |
| di:chkacttimesecs=300 | |
| ‘ | call in time |
| di:timetocalltime=2:00 am | |
| ‘ | file holds next call in time |
| di:nextcallfile=DirNextCall.txt | |
| ‘ | file that keeps track of how many times dialer wasn't found |
| di:dialernotfoundflag =dialError.txt | |
| ‘ | beginning of every line writen to log by director |
| di:dilinebegin=DI | |
| ‘ | name of main act file |
| di:mainactfile=ActsFile.txt | |
| ‘ | name of last main act file |
| di:lastmainactfile=LastActsFile.txt | |
| ‘ | name of small act file |
| di:smallactfile=SmallAct.txt | |
| ‘ | name of last main act file |
| di:lastsmallactfile=LastSmallActFile.txt | |
| ‘ | FTP channel number |
| di:channelno= 0 | |
| ‘ | FTP home |
| di:ceserver=Classiviews.com | |
| ‘ | FTP user name |
| di:ceuser=********* | |
| ‘ | FTP password |
| di:cepass=*********** | |
| ‘ | FTP Alternate home |
| di:bu_ceserver=Classiviews.com | |
| ‘ | FTP Alternate user name |
| di:bu_ceuser=********* | |
| ‘ | FTP Alternate password |
| di:bu_cepass=******** | |
| ‘ | how long has connection been open |
| di:connectionmins=30 | |
| ‘ | how long to wait for dialer to start |
| di:dialstart = 60 | |
| ‘ | how many days between times unused ads are deleted (−number = never) |
| di:maxnumberdaysbeforedelete=7 | |
| ‘ | location of default act |
| di:coredir=C:\Core | |
| ‘ | location of act and panel files |
| di:machinedir =Machine | |
| ‘ | location of picture files |

di:picturedir =Pictures

There are multiple layers of error handling redundancy including a global computer network, e.g., Internet, Service Provider connection failure, File Transfer Protocol Internet site failure, partial download handling error, power interruption, operating system failure, logging advertisement display times, atomic time setting, redialing and rebooting on a particular failure level, and so forth.

The next step is to download a new screen configuration <420>. With this invention the possibilities are virtually endless as will be described below. The next program step is to download parameters associated with a specific panel instruction file “ACT file”<422>. This can include, as nonlimiting examples: height, width, transition type, scroll, number of panel pictures, seconds to display, order, file size, file identification, scroll direction and speed of the scroll. There are defaults associated with each of these parameters and all panels are individually driven.

The next step is to download the actual advertising data file <426>. An illustrative but nonlimiting example would be JPEG files. This is followed by then making a query as to whether or not the advertising instruction or ACT files should be returned to the software system <428>. If the response to this query is positive, the listed files are transmitted back or returned to the system. If the response to this query is negative, then a query is made as to whether these files should be deleted <430>. If the response to this query is positive, then the files will be deleted <432>. If the response to this query is negative, then the configuration files (ACT) associated with the advertising is created <436>. The creation and publication of configuration files is automatic. The single panel instructions or ACT file is then processed <438>.

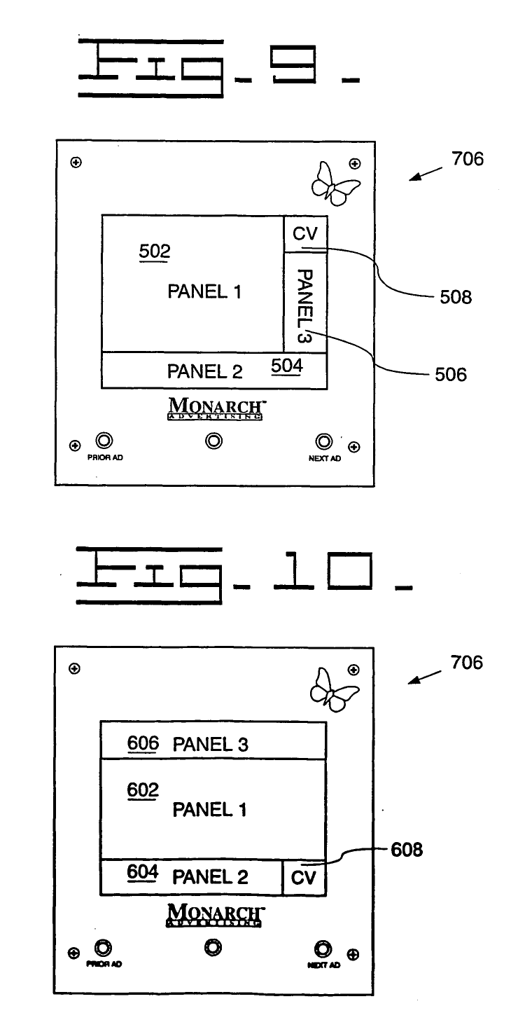

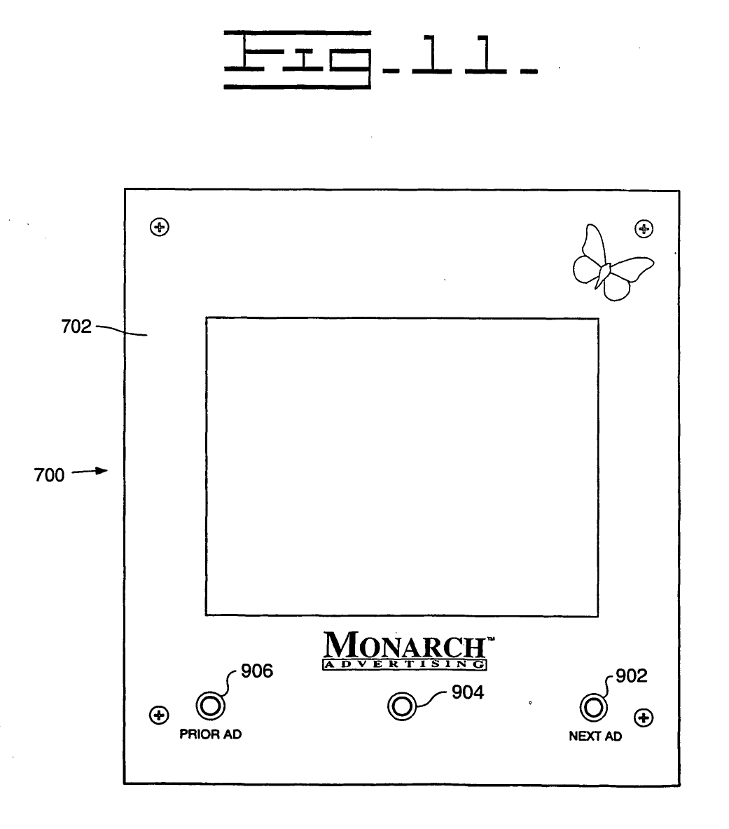

The next step is to retrieve the panel configuration files associated with a single panel instructions or ACT file <440>. The electronic display can be configured in a series of panels in a myriad of arrangements. As shown in FIG. 8, an illustrative but nonlimiting display screen is shown as generally indicated by numeral 706. There is a main display portion 502 with a bottom display panel 504 and a side display panel 506. A trademark for the software system can be displayed in small rectangular panel 508. Referring now to FIG. 9, another alternative embodiment of an illustrative but nonlimiting display screen is shown as generally indicated by numeral 706. There is a main display portion 602 with a top display panel 606 and a bottom display panel 604. A trademark for the software system can be displayed in a small rectangular panel 608. These are merely two illustrative and nonlimiting illustrations.

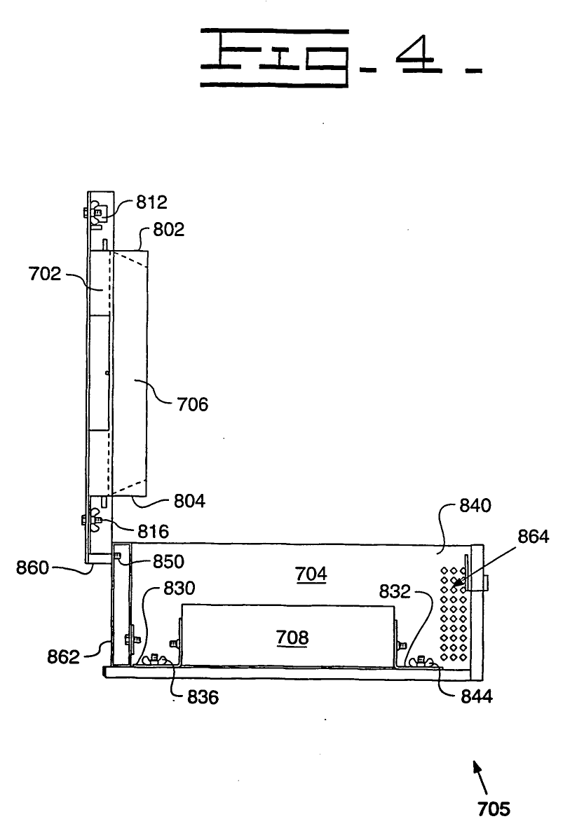

Referring again to FIG. 4, after retrieving the panel configuration files, then the software enters a panel software loop <442>. The first step in the panel software loop is to retrieve the percentage of a specific panel in the top and left portion in relation to the entire electronic display screen 706 <444>. This is followed by retrieving the percentage of a specific panel in relation to the width and height of the entire electronic display screen 706 <446>. The percentages of the specific panel in the top portion and left portion of the entire electronic display 706 as well as the percentages of the specific panel of the width and height in relation to the entire electronic display are then converted into twips <448>. Twips are units of measurement used in graphics, which represent 1/1440 of an inch or 1/20 of a printer's point. There are 1440 twips to an inch and 567 twips to a centimeter. Twips are measurements that are screen-independent.

The next step is to convert the twips to pixels <450>. A pixel is a picture 30 element and is a single point in a digital graphic image. With a color monitor, each pixel represents three dots (red, blue, and green). With the preferred liquid crystal diode display, there is a display size of 1024×768 pixels SVGA system with a top panel 502 in FIG. 5 displaying a height of 682 pixels and the bottom panel 504 being a scrolling marquee of 86 pixels.

The next step is to write this pixel information to a text file <452> and start the display subroutine 454. This subroutine involves starting the display subroutine 466, reading the pixel information text file <468>, setting the panel size <470>, setting the looping function for creating a duration of time for showing the advertisement on the electronic display 706 <472>, loading the next advertisement file <474> and showing it for a period of time in seconds <476>. Upon completion of the display subroutine, a query is made as to how many panels are to be displayed. If there are more panels to be displayed, a counter of the number of panels is incremented by one <451> and the software program returns to step <442> to continue the panel loop. If no more panels require displaying, then a control loop in the software is entered <458>. A determination is made if it is time to call to retrieve another advertisement from the system <460>. If this query is negative, another panel configuration or ACT file is ready to be displayed <464> and the software returns to step <438> for processing. If the query as to whether it is time to call global computer network, e.g., Internet, service provider to retrieve new advertisements is positive <460>, then the software system makes sure that there was a hang-up for the dial-up network from process step <430>. The software program then returns to process step <418> to start the dial-up process. If it is not time for the next single panel instructions or ACT file in step <462>, then the software returns to the start of the control loop <458>. Either MICROSOFT® WINDOWS® or UNIX® operating system can be used with the present invention.

This patent application is intended to cover all aspects of providing advertisements on an electronic display. Any type of data storage device or data transfer device will suffice to provide the advertisements. An alternative to a global computer network, e.g., Internet is the use of satellite and wireless technology. An example of using satellite technology with a global computer network, e.g., Internet is disclosed in U.S. Pat. No. 6,105,060, entitled: “system for Providing Global Portable Internet Access Using Low Earth Orbit Satellite and Satellite Direct Radio Broadcast System”, which issued Aug. 15, 2000 to Rothblatt and is incorporated herein by reference.

A first alternative embodiment is the use of encoded local advertisements sent by satellite and then decoded locally with a receiver associated with an electronic display. Each receiver would decode the appropriate want ads associated with a particular electronic display. The transmission of video content via satellite is disclosed in U.S. Pat. No. 6,111,611 issued to Ozkan et al. on Aug. 29, 2000 and is incorporated herein by reference.

### INDUSTRIAL APPLICABILITY

The present invention is advantageously applicable in presenting local advertisements to customers on an electronic display. This is a powerful marketing tool to attract customers to advertisements that that would not be motivated enough to review the newspaper or specialized publications for advertisements. This format can show full color pictures with much more information as to the condition, quality, color, dimensions, and so forth of the particular goods or services offered for sale. This decreases the amount of time the advertiser spends in answering questions over the phone or in person. This system is utilized in conjunction with a website on a global computer network, e.g. Internet, so that virtually all possible information about a particular product or service can be imparted to the consumer with full searching capabilities.

Other aspects, objects and advantages of the present invention can be obtained from a study of the drawings, the disclosure and the appended claims.

1. A method for displaying advertising comprising:
downloading at least one advertisement from a data storage device or a data transfer device with at least one processor that is in electronic communication with the data storage or the data transfer device; and
displaying the at least one advertisement on a predetermined number of electronic displays of a plurality of electronic displays, wherein the plurality of electronic displays are operatively connected to the at least one processor.

2. The method for displaying advertising according to claim 1, wherein the displaying the at least one advertisement is on at least one panel of a plurality of panels visually appearing on each of the predetermined number of electronic displays.

3. The method for displaying advertising according to claim 1, wherein the displaying the at least one advertisement on the predetermined number of electronic displays is at a predetermined time for a predetermined duration of time.

4. The method for displaying advertising according to claim 1, wherein the displaying of the at least one advertisement on the predetermined number of electronic displays is repeated during a predetermined time interval.

5. The method for displaying advertising according to claim 1, further including, prior to downloading at least one advertisement from a data storage device or a data transfer device, the following:
uploading at least one advertisement to a data storage device or a data transfer device; and
uploading information associated with the at least one advertisement selected from the group consisting of duration of display for the at least one advertisement, time of display of the at least one advertisement, number of repeated showings for the at least one advertisement and any combination thereof.

6. The method for displaying advertising according to claim 1, further including downloading information that deletes at least one advertisement from the at least one processor.

7. The method for displaying advertising according to claim 1, wherein the electronic communication between the data storage device or the data transfer device and the at least one processor is selected from the group consisting of modems, network cards, wireless communication, satellite communication and any combination thereof.

8. The method for displaying advertising according to claim 1, wherein each electronic display of the plurality of electronic displays is selected from the group consisting of a liquid crystal diode display, a plasma screen and a cathode ray tube.

9. A method for displaying advertising comprising:
downloading a plurality of advertisements from a data storage device or a data transfer device with at least one processor that is in electronic communication with the data storage device or the data transfer device;
downloading a plurality of data files that are in one to-one correspondence with the plurality of advertisements, wherein the plurality of data files provide information selected from the group consisting of a duration of display for each advertisement, a number of times that each advertisement is shown and a predetermined time when each advertisement is shown; and
displaying of the plurality of advertisements on a predetermined number of electronic displays of a plurality of electronic displays.

10. The method for displaying advertising according to claim 9, further including:
updating the at least one processor with recompiled data from the group consisting of processor information, at least one predetermined grouping of processors, at least one advertising data file, at least one panel configuration file and combinations thereof; processing logs of stains information selected from the group consisting of processor status information, system status information and advertising information at least one processor;
updating a data storage device or a data transfer device that provides access to advertising information; and
providing process alerts when errors or discrepancies are encountered by the at least one processor.

11. The method for displaying advertising according to claim 9, further including inputting at least one advertisement of the plurality of advertisements into a file that is accessible from the data storage device or the data transfer device

12. The method for displaying advertising according to claim 11, further including:
associating descriptive material for at least one advertisement of the plurality of advertisements;
receiving customer contact information for at least one advertisement of the plurality of advertisements; and
receiving payment information for at least one advertisement of the plurality of advertisements.

13. The method for displaying advertising according to claim 12, wherein the descriptive material associated with at least one advertisement of the plurality of advertisements is selected from the group consisting of an advertising category for the at least one advertisement of the plurality of advertisements, an advertising title for the at least one advertisement of the plurality of advertisements, a predetermined number of electronic displays that will show the at least one advertisement of the plurality of advertisements, the starting date for the at least one advertisement of the plurality of advertisements, the duration of showing for the at least one advertisement of the plurality of advertisements, a template type for the at least one advertisement of the plurality of advertisements, descriptive text associated with the at least one advertisement of the plurality of advertisements and any combination thereof.

14. The method for displaying advertising according to claim 12, wherein the customer contact information associated with the at least one advertisement of the plurality of advertisements is selected from the group consisting of a customer identification code, a business name, a contact name, a daytime phone, a nighttime phone, a fax number, an e-mail address, a processor identification and any combination thereof.

15. The method for displaying advertising according to claim 12, wherein the payment information associated with the at least one advertisement of the plurality of advertisements is selected from the group consisting of a payment method, an amount of cash, a bank card number, an expiration date for a bank card, a check number, a routing code for a check and any combination thereof.

16. The method for displaying advertising according to claim 9, further including:
altering at least one advertisement of the plurality of advertisements stored on the at least one processor, and
reselecting a predetermined number of the plurality of electronic displays that will display the at least one advertisement of the plurality of advertisements.

17. The method for displaying advertising according to claim 9, wherein a predetermined subset of the plurality of advertisements are simultaneously displayed on the predetermined number of electronic displays.

18. A method for displaying advertising comprising:
setting a resolution for at least one electronic display with at least one processor;
downloading an electronic display configuration with the at least one processor;
downloading at least one advertising data file configuration with the at least one processor;
downloading at least one panel configuration file configuration with the at least one processor;
determining at least one percentage of an attribute for a panel in relationship to an attribute for the at least one electronic display with the at least one processor;
converting the at least one percentage of an attribute for a panel to graphical display information for the at least one electronic display with the at least one processor;
writing the graphical display information to a text file with the at least one processor;
reading the graphical display information from the text file with the at least one processor;
setting a size for the panel as a function of the graphical display information for the at least one advertisement with the at least one processor;
loading the at least one advertising data file with the at least one processor; and
displaying the at least one advertising data file within the panel for a predetermined duration of time on at least one electronic display.

19. The method for displaying advertising according to claim 18, wherein the at least one percentage of an attribute for the panel is selected from the group consisting of a top portion of the panel, a bottom portion of the panel, a left portion of the panel, a right portion of the panel, a width of the panel and a height of the panel in relation to the electronic display.

20. The method for displaying advertising according to claim 18, wherein the converting of the at least one percentage to graphical display information for the at least one electronic display includes:
converting the at least one percentage of an attribute for the panel to graphical display information into twips; and
converting the value of twips corresponding to the graphical display information for the at least one percentage of an attribute for the panel into pixels.

21. A system for displaying advertising comprising:
at least one processor;
a data storage device or a data transfer device that is in electronic communication with the at least one processor; and
a plurality of electronic displays that is in electronic communication with the at least one processor, wherein the at least one processor downloads at least one advertisement from a data storage device or a data transfer device and displays the at least one advertisement on a predetermined number of electronic displays of the plurality of electronic displays.

22. The system for displaying advertising according to claim 21, wherein the at least one processor is utilized to display at least one advertisement on at least one panel of a plurality of panels visually appearing on each of the predetermined number of electronic displays of the plurality of electronic displays.

23. The system for displaying advertising according to claim 21, wherein the at least one processor is utilized to display at least one advertisement at a predetermined time for a predetermined duration on each of the predetermined number of electronic displays of the plurality of electronic displays.

24. The system for displaying advertising according to claim 21, wherein the processor is utilized to repeatedly display at least one advertisement during a predetermined time period on each of the predetermined number of electronic displays of the plurality of electronic displays.

25. The system for displaying advertising according to claim 21, wherein the at least one processor uploads at least one advertisement to a website on the data storage device or the data transfer device and the at least one processor uploads information associated with the at least one advertisement selected from the group consisting of a duration of display, a time of display, a number of repeated showings and any combination thereof.

26. The system for displaying advertising according to claim 21, wherein the at least one processor downloads information that deletes at least one advertisement from at least one processor.

27. The system for displaying advertising according to claim 21, further including an electronic communication mechanism for providing electronic communication between the at least one processor and the data storage device or the data transfer device selected from the group consisting of modems, network cards, wireless communication, satellite communication and any combination thereof.

28. The system for displaying advertising according to claim 21, wherein the at least one electronic display is selected from the group consisting of a liquid crystal diode display, a plasma screen and a cathode ray tube.

29. A system for displaying advertising comprising:
at least one processor;
a data storage device or a data transfer device, wherein the at least one processor is in electronic communication with the data storage device or the data transfer device; and
a plurality of electronic displays electrically connected to the at least one processor, wherein a plurality of advertisements are downloaded from the data storage device or the data transfer device with the at least one processor and a plurality of data files that are in a one-to-one correspondence with the plurality of advertisements that are downloaded with the at least one processor, wherein the plurality of data files provide information selected from the group consisting of duration of showing for each advertisement, number of times that each advertisement is shown and a predetermined time when each advertisement is shown and the plurality of advertisements are displayed on a predetermined number of electronic displays of a plurality of electronic displays.

30. The system for displaying advertising according to claim 29, wherein the at least one processor inputs a plurality of advertisements into the processor.

31. The system for displaying advertising according to claim 29, wherein the at least one processor is capable of receiving input of descriptive material associated with the plurality of advertisements and the processor is capable of receiving customer contact information for the plurality of advertisements and the at least one processor is capable of receiving payment information for each advertisement of the plurality of advertisements.

32. The system for displaying advertising according to claim 31, wherein the descriptive material with each advertisement of the plurality of advertisements is selected from the group consisting of an advertising category, an advertising title, a predetermined number of electronic displays that will show the at least one advertisement, the starting date for each advertisement of the plurality of advertisements, the duration of showing for each advertisement of the plurality of advertisements, a template type for each advertisement of the plurality of advertisements, descriptive text associated with for each advertisement of the plurality of advertisements and any combination thereof and the customer contact information associated with each advertisement that is selected from the group consisting of a customer identification, a business name, a contact name, a daytime phone, a nighttime phone, a fax number, an e-mail address, a processor number and any combination thereof and the customer contact information associated with each advertisement is selected from the group consisting of a customer identification code, a business name, a contact name, a daytime phone, a nighttime phone, a fax number, an e-mail address, a processor identification and any combination thereof and the payment information associated with each advertisement is selected from the group consisting of a payment method, amount of cash, a bank card number, an expiration date for a bank card, a check number, a routing code for a check and any combination thereof.

33. The system for displaying advertising according to claim 29, wherein the at least one processor is capable of altering at least one advertisement of the plurality of advertisements stored on the at least one processor.

34. The system for displaying advertising according to claim 29, wherein the at least one processor simultaneously displays on the at least one electronic display a predetermined subset of the plurality of advertisements

35. A system for displaying advertising comprising:
at least one processor;
a data storage device or a data transfer device that is in electronic communication with the at least one processor; and
at least one electronic display that is electrically connected to the at least one processor, wherein the at least one processor determines resolution for the at least one electronic display, downloads an electronic display configuration from the data storage device or the data transfer device, downloads at least one advertising data file from the data storage device or the data transfer device, downloads at least one panel configuration file from the data storage device or the data transfer device, determines at least one percentage of an attribute for a panel in relationship to an attribute for the at least one electronic display, converts the at least one percentage of an attribute for a panel to graphical display information for the at least one electronic display, writes the graphical display information to a text file, reads the graphical display information from the text file, sets a size for the panel as a function of the graphical display information for the at least one advertisement, loads the at least one advertising data file, and displays the at least one advertising data file within the panel for a predetermined duration of time on the at least one electronic display.

36. The system for displaying advertising according to claim 35, wherein the at least one percentage of an attribute for a panel is selected from the group consisting of a top portion of the panel, a bottom portion of the panel, a left portion of the panel, a right portion of the panel, a width of the panel and a height of the panel in relation to the electronic display.

37. The system for displaying advertising according to claim 36, wherein the at least one processor converts of the at least one percentage to graphical display information for the at least one electronic display by converting the at least one percentage of an attribute for a panel to graphical display information into twips and converting the value of twips corresponding to the graphical display information for the at least one percentage of an attribute for a panel into pixels.

38. A data processing system for displaying advertising utilizing an application program comprising:
a processor for processing the application program;
a database of at least one advertising data file; and
a database of at least one panel configuration file, wherein the processor utilizes the database of the at least one advertising data file and the database of the at least one panel configuration file on a one-tone corresponding basis to display an advertising data file with an associated panel on at least one electronic display.

39. A software program product for use in displaying advertising comprising:
a computer usable medium for causing a processor to associate an advertising data file with a file of associated information for displaying the advertising data file on at least one electronic display.

40. The software program product for use in displaying advertising according to claim 39, wherein the file of associated information is selected from the group consisting of a duration of showing for each advertisement, a number of times that each advertisement is shown, a predetermined time when each advertisement is shown and panel configuration information.

41. A system for displaying advertising comprising:
at least one processor;
a data storage device or a data transfer device that is in electronic communication with the at least one processor;
at least one electronic display that is in electronic communication with the at least one processor, wherein the at least one processor downloads a plurality of advertisements from the data storage device or the data transfer device and sequentially displays the plurality of advertisements on a predetermined number of electronic displays of the plurality of electronic displays; and
at least one switch that is electrically connected to the processor that allows the plurality of advertisements to be viewed in a group consisting of moving forward though a sequence of the plurality of advertisements, moving backward through the sequence of the plurality of advertisements and obtaining additional information regarding a particular advertisement of the plurality of advertisements.
